(19) United States
(12) Patent Application Publication
(10) Pub. No.: US 2021/0263254 A1
(43) Pub. Date: Aug. 26, 2021

(54) OPTICAL FIBER CABLE WITH LASER WELDED JACKET AND METHOD OF MANUFACTURING

(71) Applicant: CORNING RESEARCH & DEVELOPMENT CORPORATION, Corning, NY (US)

(72) Inventors: Warren Welborn McAlpine, Hickory, NC (US); Eric James Paulus, Corning, NY (US); Pushkar Tandon, Painted Post, NY (US)

(21) Appl. No.: 17/318,105

(22) Filed: May 12, 2021

Related U.S. Application Data
(63) Continuation of application No. PCT/US2019/062176, filed on Nov. 19, 2019.
(60) Provisional application No. 62/772,818, filed on Nov. 29, 2018.

(51) Int. Cl. G02B 6/44; B23K 26/262; B29C 65/16

(52) U.S. Cl. CPC G02B 6/4486; G02B 6/4429; B29K 2101/12; B29C 65/16; B23K 26/262

(57) ABSTRACT

An optical cable and method for forming an optical cable is provided. The cable includes a cable jacket including an inner surface defining a channel and an outer surface. The cable includes a seam within the cable jacket that couples together opposing longitudinal edges of a wrapped thermoplastic sheet which forms the cable jacket and maintains the cable jacket in the wrapped configuration around the plurality of optical fibers. The method includes forming an outer cable jacket by wrapping a sheet of thermoplastic material around a plurality of optical core elements. The method includes laser welding together portions of thermoplastic material of opposing longitudinal edges of the wrapped sheet such that a seam is formed holding the sheet of thermoplastic material in the wrapped configuration around the core elements.

### CROSS-REFERENCE TO RELATED APPLICATIONS

This application is a continuation of International Application No. PCT/US2019/062176 filed on Nov. 19, 2019, which claims the benefit of priority under 35 U.S.C. § 119 of U.S. Provisional Application Ser. No. 62/772,818 filed on Nov. 29, 2018, the content of each of which is relied upon and incorporated herein by reference in their entirety.

### BACKGROUND

The disclosure relates generally to cables and more particularly to fiber optic cables having a laser welded cable jacket. Optical cables have seen increased use in a wide variety of fields including various electronics and telecommunications fields. Optical cables contain or surround one or more optical fibers. The cable provides structure and protection for the optical fibers within the cable.

### SUMMARY

One embodiment of the disclosure relates to an optical cable. The optical cable includes a plurality of optical fibers and an outer jacket. The outer jacket includes a sheet of thermoplastic material wrapped around the plurality of optical fibers such that the optical fibers are surrounded by the wrapped sheet of thermoplastic material. The outer jacket includes an outer surface of the wrapped sheet of thermoplastic material that defines the outermost surface of the cable. The cable includes a welded seam coupling together opposing longitudinal edges of the wrapped thermoplastic sheet and maintaining the outer jacket in the wrapped configuration around the plurality of optical fibers. The welded seam is formed from portions of the wrapped sheet of thermoplastic material at the opposing longitudinal edges bonded together by a laser beam.

An additional embodiment of the disclosure relates to an optical cable. The optical cable includes a cable jacket having an inner surface defining a channel and an outer surface. The optical cable includes a plurality of optical transmission elements located within the channel and a seam extending longitudinally within the cable jacket. The seam couples together opposing longitudinal edges of a wrapped polymer sheet which forms the cable jacket and maintains the cable jacket in the wrapped configuration around the plurality of optical transmission elements.

An additional embodiment of the disclosure relates to a method of forming an optical cable. The method includes forming a cable jacket by wrapping a sheet of thermoplastic material around a plurality of optical core elements such that opposing longitudinal edges of the wrapped sheet contact each other from an inner surface to an outer surface. The method includes melting together portions of thermoplastic material of laser welding the longitudinal edges of the wrapped sheet such that a seam is formed holding the sheet of thermoplastic material in the wrapped configuration around the core element.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 shows a system for forming a wrapped and welded outer cable jacket according to aspects of the present disclosure.

FIG. 2 is a cross-sectional view of an optical fiber cable according to aspects of the present disclosure.

FIG. 3 is a detailed cross-sectional view of the optical fiber cable of FIG. 2 according to aspects of the present disclosure.

FIG. 4 is a detailed cross-sectional view of the optical fiber cable shown in FIG. 2 illustrating a method of forming a laser welded seam according to aspects of the present disclosure.

FIG. 5 is another cross-sectional view of the optical fiber cable of FIG. 2 illustrating a method of forming a laser welded seam according to aspects of the present disclosure.

FIG. 6 is a graph to illustrate the temperature profile as a function of position for a jacket using a butt-weld according to aspects of the present invention.

FIG. 7 is a graph to illustrate the temperature profile as a function of position for a jacket using a laser weld method according to aspects of the present invention.

### DETAILED DESCRIPTION

Referring generally to the figures, various embodiments of an optical fiber cable and methods for making an optical fiber cable are shown. In general, the cable embodiments discussed herein include a cable jacket, e.g., an outer cable jacket, formed from a pre-extruded sheet of thermoplastic material. The outer cable jacket is formed by wrapping the thermoplastic sheet around the various optical cable core components (e.g., optical fibers, buffer tubes, strength elements, water blocking materials, armor layers, binder layers, etc.), and by then forming a seam to couple together the opposing sheet edges to hold the wrapped sheet in the desired position around the core elements. In particular embodiments, the seam is formed by a welding process (e.g., a high throughput laser welding process) that melts together the opposing sheet edges such that a circumferentially contiguous outer cable jacket is formed.

In contrast to conventional processes in which the outer cable jacket is extruded around the core components inline with the other cable assembly steps, the system of the present application is believed to enable higher throughput cable assembly through high speed wrapping and seam welding. In addition, the seam formation process discussed herein provides the ability to design and select particular seam properties. For example, in accordance with aspects of the present invention, the seam formation process discussed herein does not rely on conventional butt-welding or overlap-welding to form the seam. Rather, the two surfaces forming the seam interface are brought together in a predetermined contact pattern while a laser is translating over the seam to create a more uniform seam bond along the entirety of the seam interface.

In addition, in specific embodiments, by utilizing a pre-extruded sheet of material to form the cable jacket, the system of the present disclosure allows for the material of the cable jacket to be cross-linked (e.g., through use of an electron beam, x-ray beam, etc.). Cross-linking is believed to increase cable jacket strength and to reduce the shrinkage experienced by the cable jacket over time as compared to conventional non-cross-linked, inline extruded cable jackets. Further, it is believed that by utilizing a pre-extruded sheet for the cable jacket, the cross-linking energy source may be applied to both major surfaces of the pre-extruded sheet prior to wrapping, providing superior levels of cross-linking.

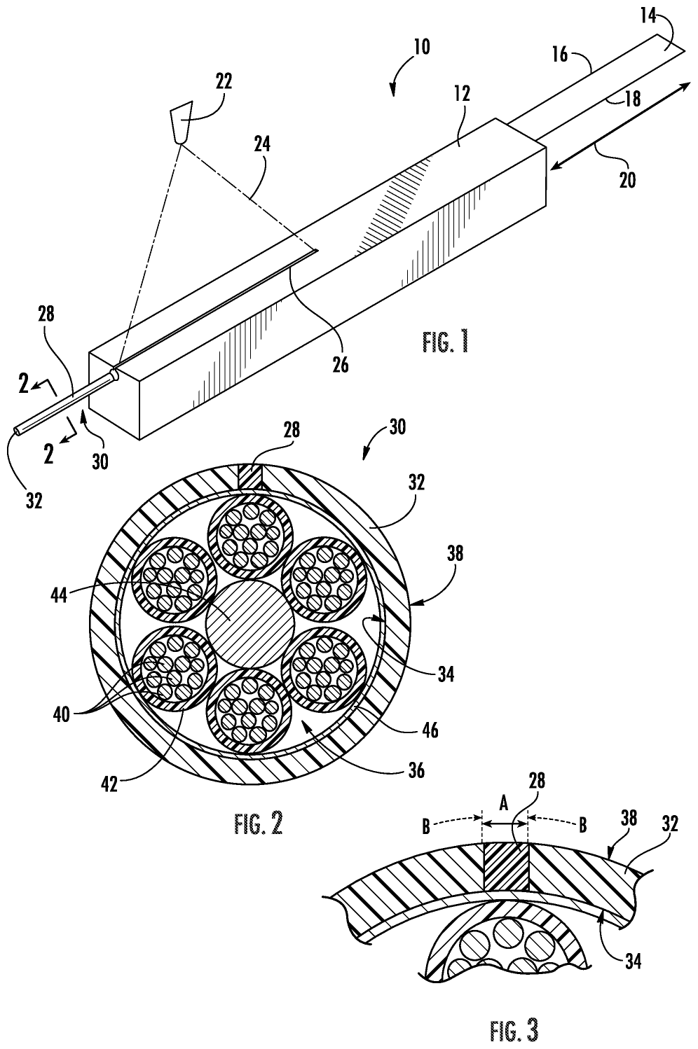

Referring to FIG. 1, a system 10 for forming a wrapped cable jacket, such as an outer cable jacket, is shown according to aspects of the present disclosure. System 10 may include a forming block 12 which receives a pre-extruded sheet 14 of polymer jacket material (e.g., a thermoplastic jacket material). Sheet 14 has opposing longitudinal edges 16 and 18 and a longitudinal axis 20.

Sheet 14 is advanced into forming block 12 in the direction of longitudinal axis 20. It will be understood that all of the other cable core components that will be surrounded by the cable jacket formed from sheet 14 are also advanced into forming block 12. Within forming block 12, sheet 14 is wrapped around the cable core components such that a generally tubular structure is formed from sheet 14 surrounding the cable core components.

System 10 includes a laser 22 that generates a laser beam 24. Laser beam 24 is directed through opening 26 in forming block 12 toward the material of the opposing edges 16 and 18 of sheet 14 such that laser beam 24 interacts with wrapped sheet 14. Specifically, laser beam 24 melts the thermoplastic material of the portions of sheet 14 adjacent the longitudinal edges 16 and 18 together such that a seam, shown as welded seam 28, is formed. It is believed that in at least some embodiments, utilizing a high speed, high throughput laser device 22 may allow for formation of seam 28 and the associated cable at higher speeds than typically achieved with conventional inline jacket extrusion processes.

As shown in FIG. 1, seam 28 extends in the direction of longitudinal axis 20, and seam 28 couples together the sections of sheet 14 adjacent longitudinal edges 16 and 18 such that sheet 14 is maintained in the wrapped shaped. In various embodiments, seam 28 extends all or substantially all of the longitudinal length of cable 30, and in specific embodiments, the longitudinal length of seam 28 is greater than 10 cm, greater than 1 m, greater than 10 m, greater than 100 m, etc.

In various embodiments, sheet 14 is formed from a pre-extruded sheet of thermoplastic material. In various embodiments, sheet 14 may be a variety of materials used in cable manufacturing such as polyethylene, medium density polyethylene, polyvinyl chloride (PVC), polyvinylidene difluoride (PVDF), nylon, polyester or polycarbonate and their copolymers. In addition, the material of sheet 14 may include small quantities of other materials or fillers that provide different properties to the material of sheet 14. For example, sheet 14 may include materials that provide for coloring, UV/light blocking (e.g., carbon black), burn resistance, etc.

Following formation of seam 28, optical cable 30 exits the forming block 12 having a wrapped, tubular outer cable jacket 32 surrounding the cable core elements. Referring to FIG. 2, a cross-sectional view of an optical cable 30 including a wrapped cable jacket, such as outer cable jacket 32, is shown according to an exemplary embodiment. Outer cable jacket 32 has an inner surface 34 that defines an inner passage or cavity, shown as central bore 36, and an outer surface 38 that generally defines the outermost surface of cable 30. As will be generally understood, inner surface 34 of jacket 32 defines an internal area or region within which the various cable components discussed herein are located, and jacket 32 is held in the wrapped configuration shown in FIG. 2 by the welded seam 28 joining together the opposing edges of the wrapped sheet 14. Further, while FIG. 2 shows an outer cable jacket 32 formed from sheet 14, sheet 14 can be wrapped and welded to form a variety of other thermoplastic cable layers, such as inner cable jackets, thermoplastic binding layers, etc. Applicant believes that by utilizing a pre-extruded sheet 14 (as opposed to extruding the jacket material around cable components) a higher throughput and/or lower cost process for forming an optical cable is provided.

Cable 30 includes one or more optical transmission elements or optical waveguides, shown as optical fibers 40. In the embodiment shown, groups of optical fibers 40 are located in a plurality of buffer tubes 42, and buffer tubes 42 are wrapped (e.g., in an SZ stranding pattern) around a central strength member 44. Central strength member 44 may be any suitable axial strength member, such as a glass-reinforced plastic rod, steel rod/wire, etc. Generally, cable 30 provides structure and protection to optical fibers 40 during and after installation (e.g., protection during handling, protection from elements, protection from the environment, protection from vermin, etc.). In other embodiments, the optical fibers of cable 30 are any optical fiber transmission arrangement, including tight buffered optical fibers, optical fiber ribbons, optical fiber ribbon stacks, etc.

In various embodiments, cable 30 also includes an armor layer, shown as armor 46. In general, armor 46 is formed from a strip of metal material (e.g., a metal tape, a flat elongate continuous piece of material, etc.) that is wrapped around and circumferentially surrounds buffer tubes 42. As shown in FIG. 2, armor 46 is located adjacent to the inner surface of outer jacket 32 such that these two layers are in contact with each other. In specific embodiments, armor 46 is corrugated steel tape material that is wrapped around the interior portions of cable 30, and in some such embodiments, armor 46 is longitudinally folded forming a longitudinal overlapped section where opposing edges of the tape overlap to completely surround buffer tubes 42 (and any other interior component of cable 30). In other embodiments, armor 46 may be a strip of metal tape material, helically wrapped around buffer tubes 42 such that armor 46 forms a layer circumferentially surrounding buffer tubes 42. In general, armor layer 46 provides an additional layer of protection to fibers 40 within cable 30, and may provide resistance against damage (e.g., damage caused by contact or compression during installation, damage from the elements, damage from rodents, etc.). Cable 30 may include a variety of other components or layers, such as helically wrapped binders, circumferential constrictive thin-film binders, water blocking tape materials, water-blocking fiber materials, etc.

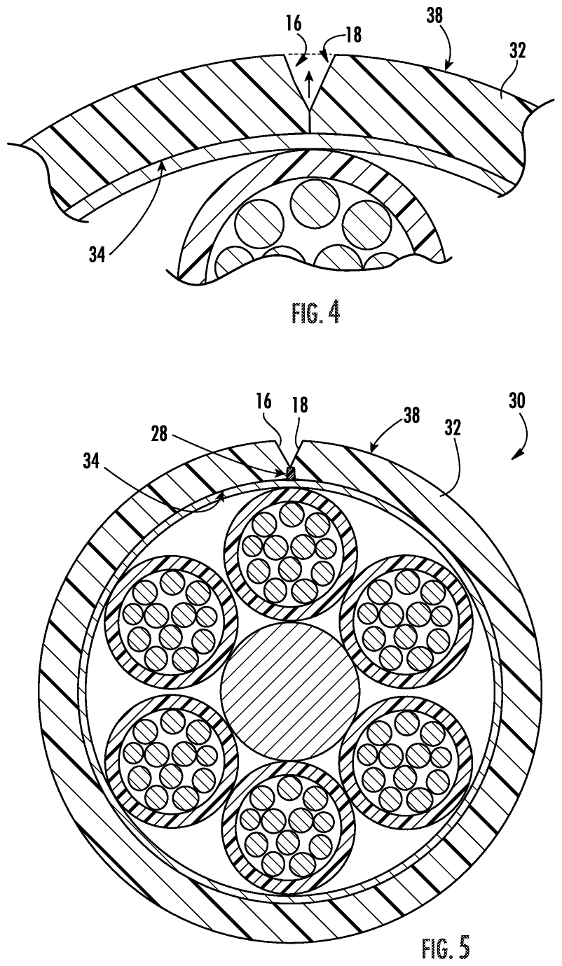

Referring to FIG. 3, seam 28 is shown in more detail. As shown in FIG. 3, seam 28 is a laser welded seam that extends the entire thickness of jacket 32 in the radial direction. In such embodiments, seam 28 extends from inner surface 34 to outer surface 38. Further, seam 28 has an arc length shown as length A, and the portion of jacket 32 outside of seam 28 has an arc length shown as B. As will be understood, arc lengths A and B together total 360 degrees. In particular embodiments, length A is a relatively small portion of the total circumference of jacket 32. In particular embodiments, length A is less than 40 degrees, specifically less than 20 degrees, more specifically less than 10 degrees and even more specifically less than 5 degrees. In various embodiments, the length B outside of seam 28 is greater than 270 degrees, specifically greater than 300 degrees, more specifically is greater than 330 degrees, and even more specifically is greater than 350 degrees.

Referring to FIG. 4 and FIG. 5, the process for forming seam 28 in cable 30 is shown according to an exemplary embodiment. Longitudinal edges 16 and 18 are brought together as shown in FIG. 4 such that each edge first makes controlled contact with the other edge along inner surface 34. As described above with reference to FIG. 1, laser 22 is simultaneously controlled to translate laser beam 24 along the seam interface (e.g., focusing laser 22 to different depths) during seam formation. As shown in FIG. 5, seam 28 begins to form at a location. Longitudinal edges 16 and 18 are gradually brought together in a zipping process from inner surface 34 toward outer surface 38 (see arrow in FIG. 4) as the laser beam 24 continues to translate. A ratio of characteristic time for interface zipping to form seam 28 to characteristic time for laser spot translation results in desired temperatures at all depths of the seam 28 along the entire length of the strip weld. Although the seam 28 shown in FIGS. 4 and 5 forms from an inner surface 34 toward the outer surface 38, aspects of the present disclosure also contemplate formation of the seam 28 from the outer surface 38 toward the inner surface 34, for example. In addition, in accordance with yet other aspects of the present disclosure, translation of the laser beam 24 may be controlled to form a seam 28 that does not encompass the entire thickness of the jacket 32. As such, the seam 28 may be formed as described herein to a certain depth from the outer surface 38, leaving a small notch that runs longitudinally the length of the cable to provide easier access to the core and/or to provide a valley for print and/or to provide a tactile or visual feature that may be aligned with a particular feature in the core of cable 30, such as a rip cord or an armor seam.

The jacket welding process disclosed herein allows for the entire thickness of the weld seam to experience temperatures in a range that are conducive for laser welding, i.e., avoiding temperatures on the top or outer surface 38 of the weld seam 28 to become too hot or temperatures at the bottom or inner surface 34 of the weld seam 28 to be too cold.

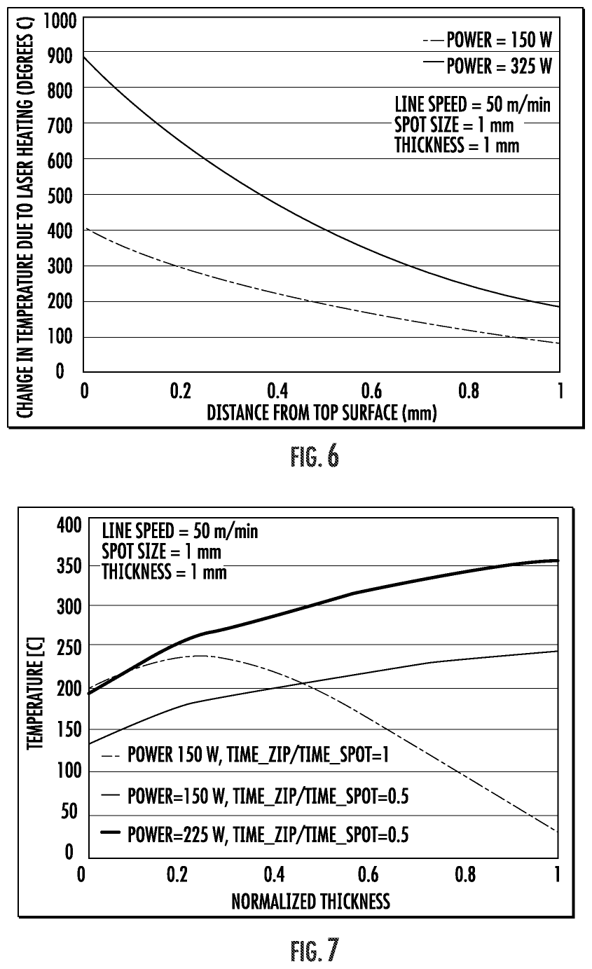

FIG. 6 illustrates the calculated temperature profile as a function of position across the thickness of a 1 mm polyethylene strip when a thermoplastic sheet comprising polyethylene is welded in a butt-weld mode (i.e., entire thickness of longitudinal edges in full contact) using a CO₂ laser having a spot size of 1 mm at line speeds of 50 meters per minute. It is observed that, when using a laser with a power of 150 W, the temperature of the top or outer surface of the jacket strip at the location of the seam heats to approximately 400° C., yet the temperature of the bottom surface or inner surface of the seam only reaches approximately 100° C. An effective weld across the thickness of the weld-seam cannot be achieved as local temperatures above 150° C. are generally required for effective welding of polyethylene strips. Repeating the process with a laser having a power of 325 W results in a temperature at the bottom or inner surface of approximately 200° C. and a temperature on the top or outer surface that is in excess of 800° C. The polyethylene strip is unable to withstand the high temperature on the top or outer surface resulting in destruction or degradation of the polyethylene strip.

FIG. 7 shows the calculated temperature profile across the thickness of the same jacket strip when using the zipping process described herein. The graph shows different ratios of characteristic time for seam interface zipping to the characteristics time of laser beam exposure using a carbon dioxide (CO₂) laser having a spot size of 1 millimeter at line speeds of 50 meters per minute. When the ratio of characteristic time for seam interface closure (i.e., seam zipping or the time to engage full contact of the longitudinal edges across the width of the seam from a radial inner surface to the radial outer surface) to the characteristic time of laser beam exposure (i.e., the time of laser beam exposure in the particular area being sealed) is about 1, the top half of the strip becomes heated to temperatures satisfactory for effective welding of the strip ends, but the bottom half of the strip shows temperatures that are too low for forming a good weld. However, as shown in FIG. 7, when the ratio of characteristic time for seam interface zipping to the characteristics time of laser beam exposure is decreased to 0.5, the temperatures across the thickness of the strip during seam formation remain between 150° C. and 450° C., which is in the range for a good weld across the strip thickness without causing damage to the jacket material. For effective welds using this process, the characteristic time for seam interface zipping to the characteristic time of laser beam exposure is preferably between 0.25 and 0.7.

While the specific cable embodiments discussed herein and shown in the figures relate primarily to cables that have a substantially circular cross-sectional shape defining a substantially cylindrical internal bore, in other embodiments, the cables discussed herein may have any number of cross-section shapes. For example, in various embodiments, cable jacket 32 may have an oval, elliptical, square, rectangular, triangular or other cross-sectional shape. In such embodiments, the passage or lumen of the cable may be the same shape or different shape than the shape of cable jacket 32. In some embodiments, cable jacket 32 may define more than one channel or passage. In such embodiments, the multiple channels may be of the same size and shape as each other or may each have different sizes or shapes.

The optical transmission elements discussed herein include optical fibers that may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate, and chalcogenide glasses, as well as crystalline materials, such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber. The optical transmission elements discussed herein can include a wide variety of optical fibers including multi-mode fibers, single mode fibers, bend insensitive/resistant fibers, etc. In other embodiments, the optical cables discussed herein may include multi-core optical fibers, and in this embodiment, each optical transmission element may be a single, integral optical structure having multiple optical transmission elements (e.g., multiple optical cores surrounded by cladding).

For effective welds using this process, the characteristic time for seam interface zipping to the characteristic time of laser beam exposure is preferably between 0.25 and 0.7. Because the process described herein allows efficient jacket formation, the line speed during cable manufacture may be greater than 30 meters per minute in some embodiments, greater than 50 meters/minute in other embodiments, greater than 100 meters/minute in still other embodiments, and may be even greater than 200 meters/minute in yet other embodiments. The laser beam may be selected from but is not limited to Gaussian, linear, rectangular or a combination of beams. The laser intensity may range from having a power of larger than 100 watts (W) in some embodiments, larger than 200 W in other embodiments and larger than 400 Win still other embodiments. The thickness of the jacket strips used for cable jackets may be larger than 0.5 millimeters, larger than 0.75 mm, or larger than 1 mm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of forming an optical cable comprising:
forming a cable jacket by wrapping a sheet of thermoplastic material around a plurality of optical core elements such that opposing longitudinal edges of the wrapped sheet either contact each other at one of an inner or an outer surface of the opposing longitudinal edges; and
bonding the thermoplastic material of the opposing longitudinal edges of the wrapped sheet such that a seam is formed holding the sheet of thermoplastic material in the wrapped configuration around the plurality of core elements, wherein the bonding step comprises forming the seam by translating a laser beam as the opposing longitudinal edges are brought into contact radially from the one of the inner surface or the outer surface to the other of the inner surface or the outer surface of the opposing longitudinal edges.

2. The method of claim 1, wherein a ratio of a characteristic time for seam interface closure to a characteristic time of laser beam exposure is between 0.25 and 0.7.

3. The method of claim 1, wherein a line speed for forming the optical cable is greater than 50 meters per minute.

4. The method of claim 1, wherein the cable jacket comprises a thickness greater than 0.5 millimeters.

5. The method of claim 4, wherein the thermoplastic material of the cable jacket comprises polyethylene, medium density polyethylene, polyvinyl chloride (PVC), polyvinylidene difluoride (PVDF), nylon, polyester or polycarbonate.

6. The method of claim 5, wherein the cable jacket further comprises materials that provide coloring, ultraviolet light blocking, or burn resistance.

7. The method of claim 4, wherein a range of temperatures across the thickness of the cable jacket during seam formation remains between 150° C. and 450° C.

8. The method of claim 1, wherein the plurality of core elements comprises one or more of an optical transmission element, a buffer tube, or a strength member.

9. The method of claim 8, wherein the optical transmission element comprises one or more optical fibers.

10. The method of claim 9, wherein the plurality of core elements further comprises an armor layer.

11. The method of claim 1, further comprising using a carbon dioxide (CO₂) laser for the laser beam.

12. The method of claim 11, wherein the laser beam has a spot size of 1 millimeter.

13. An optical cable, comprising:
a cable jacket comprising a sheet of thermoplastic material wrapped longitudinally around a plurality of optical core elements; and
a seam bonding the thermoplastic material of opposing longitudinal edges of the wrapped sheet and holding the sheet of thermoplastic material in the wrapped configuration around the plurality of optical core elements, wherein the seam is formed by translating a laser beam as opposing longitudinal edges of the wrapped sheet are brought into contact with each other radially from one of an inner surface or an outer surface to the other of the inner surface or the outer surface of the opposing longitudinal edges.

14. The optical cable of claim 13, wherein a ratio of a characteristic time for seam interface closure to a characteristic time of laser beam exposure is between 0.25 and 0.7.

15. The optical cable of claim 13, wherein the cable jacket comprises a thickness greater than 0.5 millimeters.

16. The optical cable of claim 13, wherein the plurality of core elements comprises one or more of an optical transmission element, a buffer tube, or a strength member.

17. The optical cable of claim 16, wherein the optical transmission element comprises one or more optical fibers.

18. The optical cable of claim 17, wherein the plurality of core elements further comprises an armor layer.

19. The optical cable of claim 13, wherein the thermoplastic material of the cable jacket comprises polyethylene, medium density polyethylene, polyvinyl chloride (PVC), polyvinylidene difluoride (PVDF), nylon, polyester or polycarbonate.

20. The optical cable of claim 19, wherein the cable jacket further comprises materials that provide coloring, ultraviolet light blocking, or burn resistance.
